(19) United States
(12) Patent Application Publication
(10) Pub. No.: US 2012/0321241 A1
(43) Pub. Date: Dec. 20, 2012

(54) INTERFEROMETER-BASED OPTICAL SWITCHING

(75) Inventors: Martin JULIEN, Laval (CA); Robert BRUNNER, Montreal (CA); Stephane LESSARD, Mirabel (CA)

(73) Assignee: TELEFONAKTIEBOLAGET L M ERICSSON (PUBL), Stockholm (SE)

(21) Appl. No.: 12/976,448

(22) Filed: Dec. 22, 2010

(51) Int. Cl. G02B 6/35; B23P 11/00; G02F 1/035

(52) U.S. Cl. 385/3; 385/20; 29/428

(57) ABSTRACT

Systems and methods according to these exemplary embodiments provide for optical interconnection using optical splitters and interferometer-based optical switching. Optical signals can be routed from an input port to one or more output ports via at least one splitter and at least one interferometer, e.g., a Mach Zehnder interferometer. According to one exemplary embodiment, signal degradation associated with signal splitting is mitigated by using a binary tree of splitters and interferometers between input ports and output ports.

### TECHNICAL FIELD

The present invention relates generally to telecommunications systems and in particular to optical switches and associated methods.

### BACKGROUND

Communications technologies and uses have greatly changed over the last few decades. In the fairly recent past, copper wire technologies were the primary mechanism used for transmitting voice communications over long distances. As computers were introduced the desire to exchange data between remote sites became desirable for many purposes. The introduction of cable television provided additional options for increasing communications and data delivery from businesses to the public. As technology continued to move forward, digital subscriber line (DSL) transmission equipment was introduced which allowed for faster data transmissions over the existing copper phone wire infrastructure. Additionally, two way exchanges of information over the cable infrastructure became available to businesses and the public. These advances have promoted growth in service options available for use, which in turn increases the need to continue to improve the available bandwidth for delivering these services, particularly as the quality of video and overall amount of content available for delivery increases.

One promising technology that has been introduced is the use of optical fibers for telecommunication purposes. Optical fiber network standards, such as synchronous optical networks (SONET) and the synchronous digital hierarchy (SDH) over optical transport (OTN), have been in existence since the 1980s and allow for the possibility to use the high capacity and low attenuation of optical fibers for long haul transport of aggregated network traffic. These standards have been improved upon and today, using OC-768/STM-256 (versions of the SONET and SDH standards respectively), a line rate of 40 gigabits/second is achievable using dense wave division multiplexing (DWDM) on standard optical fibers.

As these (and other) optical networks are being deployed, there is an increasing need to provide efficient solutions for switching and routing information within and between such networks. Currently, specialized optical switches are available for large optical networks, which specialized switches are typically extremely expensive since they are developed for specific types of core networks. In addition to providing basic switching functionality, these types of specialized optical switches also typically provide value-added features such as accounting, rate-limiting, etc.

As optical technology is maturing, the cost related to its use is decreasing. Also, as networking and communication systems are imposing greater requirements associated with capacity and sustainability, optical-based solutions are becoming more attractive for system architecture designs. However, smaller networking systems typically have different requirements than those of large optical networks. In other words, specific solutions might have to be developed on a system basis, rather than on a more generic network basis. While expensive solutions might be affordable for some networks, they might not be acceptable at a node level.

In order to build networking systems based on optical technologies, there is a need to provide simple, scalable, reliable and affordable solutions for optical switches and crossbars. The current available technologies for providing optical crossbars and switches typically require the use of mirrors and MEMS technology. Depending on the implementation, such optical switching solutions can be extremely complicated and expensive, especially when they are built for controlling traffic on networks, not for smaller-scale systems.

Moreover, the usage of mirrors and MEMS technology in optical switches brings with it certain potential drawbacks. For example, in such optical switches, mirrors are provided on printed circuit boards (PCBs) or other electronic devices. While mirrors can be used to redirect optical signals, they lack the capability of selectively reflecting only a specific optical wavelength without the help of a specific optical filter. Additionally, the use of mirrors requires more space on a PCB or an electronic device, apart from the fact that mirrors might be required to move in order to allow the optical signals to be reflected in the required direction. For the mirrors in an optical switch to move, MEMS technology can be used, which can lead to simple or complex solutions, depending on the flexibility with which the mirrors have to move. Typically, since MEMS technology is basically a means to move extremely small components or devices mechanically, there exists an inherent operation/repair risk related to limitations and problems that can arise because of such mechanical movements.

Other alternatives for building optical switches can be based on a mix of technology choices. For example, optical switches can be designed which include conversions between the optical and the electrical domains, which could allow the use of traditional layer 2 switches, such as Ethernet switches. While systems could be built relatively easily using those technologies, such solutions are expensive in terms of energy consumption, space and components. Ideally, efficient solutions should avoid any transitions from the optical domain.

Accordingly, it would be desirable to provide optical switches or crossbars which overcome the aforedescribed drawbacks.

### SUMMARY

Systems and methods according to these exemplary embodiments provide for optical interconnection using optical splitters and interferometer-based optical switching. Optical signals can be routed from an input port to one or more output ports via at least one splitter and at least one interferometer, e.g., a Mach Zehnder interferometer. According to one exemplary embodiment, signal degradation associated with signal splitting is mitigated by using a binary tree of splitters and interferometers between input ports and output ports.

According to an exemplary embodiment, an optical interconnect system includes a plurality of input ports for receiving optical signals, a plurality of input waveguides, each connected to one of the plurality of input ports, for guiding the optical signals, a plurality of output ports, a plurality of output waveguides, each connected to one of the plurality of output ports, wherein the plurality of input waveguides and the plurality of output waveguides are disposed in an orthogonal relationship, at least one connecting optical waveguide portion disposed between each input waveguide and each output waveguide to convey an optical signal from a respective input port toward a respective output port, and wherein the at least one connecting optical waveguide portion includes at least one optical splitter and at least one interferometer disposed downstream of each optical splitter to selectively block, or let pass, the optical signal toward the respective output port.

According to another exemplary embodiment, a method for conveying optical wavelengths in an optical interconnect includes the steps of receiving optical signals at a plurality of input ports, conveying the optical signals via a plurality of input waveguides, each connected to one of the plurality of input ports, splitting, at each interconnecting point between one of the plurality of input waveguides and one of a plurality of output waveguides, an optical signal from the one of the plurality of input waveguides toward the one of the output waveguides, and selectively blocking or passing the optical signal downstream of the interconnecting point using an interferometer, wherein the plurality of input waveguides and the plurality of output waveguides are disposed in an orthogonal relationship.

According to another exemplary embodiment, a method for manufacturing an optical interconnect system includes manufacturing an optical interconnect device by providing a plurality of input ports on a substrate, forming a plurality of input waveguides, each connected to one of said plurality of input ports, on the substrate, providing a plurality of output ports on the substrate, forming a plurality of output waveguides, each connected to one of the plurality of output ports, on the substrate in an orthogonal relationship relative to the plurality of input waveguides, and providing at least one optical splitter and at least one interferometer at each interconnecting point between one of the plurality of input waveguides and one of the plurality of output waveguides, each interferometer being configured to selectively block, or pass, an optical signal received from a corresponding optical splitter.

### BRIEF DESCRIPTION OF THE DRAWINGS

The accompanying drawings illustrate exemplary embodiments, wherein:

FIG. 1 depicts an exemplary three port optical interconnect device;

FIG. 2 illustrates an exemplary interferometer used according to exemplary embodiments to selectively block, or pass, an optical signal input thereto;

FIG. 3 depicts a four-port optical interconnect device according to an exemplary embodiment;

FIG. 4 depicts a portion of a four-port optical interconnect device according to another exemplary embodiment;

FIG. 5 illustrates a complete four-port optical interconnect device including the portion shown in FIG. 4;

FIG. 6 is a flowchart depicting a method for conveying optical signals according to an exemplary embodiment; and

FIG. 7 is a method flowchart illustrating a method for manufacturing an optical interconnect device according to an exemplary embodiment.

### ABBREVIATIONS/ACRONYMS

MEMS Micro-Electro-Mechanical System

MZI Mach-Zehnder Interferometer

MZM Mach-Zehnder Modulator

PCB Printed Circuit Board

PLC Planar Light wave Circuit

WDM Wavelength-Division Multiplexing

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

According to exemplary embodiments an optical crossbar or switch can be built using interferometer technology, such as Mach-Zehnder Interferometer (MZI) technology. Because the MZI technology is well-known per se and has been proven to be stable and reliable in production, it would be advantageous to develop an optical crossbar or switch based on that technology. The MZI technology is thus used in exemplary embodiments, for example, for its effect of dynamically blocking (or not) an optical signal by virtue of MZI's phase shifting capabilities.

By using a controller, the MZIs can be used to block or allow the optical signals through junctions in a switching interconnect based on an applied electric field on a splitted span of the MZIs. Since optical signals are either blocked or not at each MZI, it becomes possible to chain them together using the controller to configure the MZIs to route an optical signal and to provide a 1-to-1 or a 1-to-N relationship between an incoming port and one or several outgoing ports. In other words, it is possible to create a unicast or a multicast forwarding capability.

To allow a large number of input and output ports on the same device, an orthogonal layout (waveguides crossing at 90 degree) can be used to minimize undesired interference between any input and output waveguides. According to one exemplary embodiment, an N-level binary-tree like structure is used at each input port in order to minimize the number of optical signal degradations.

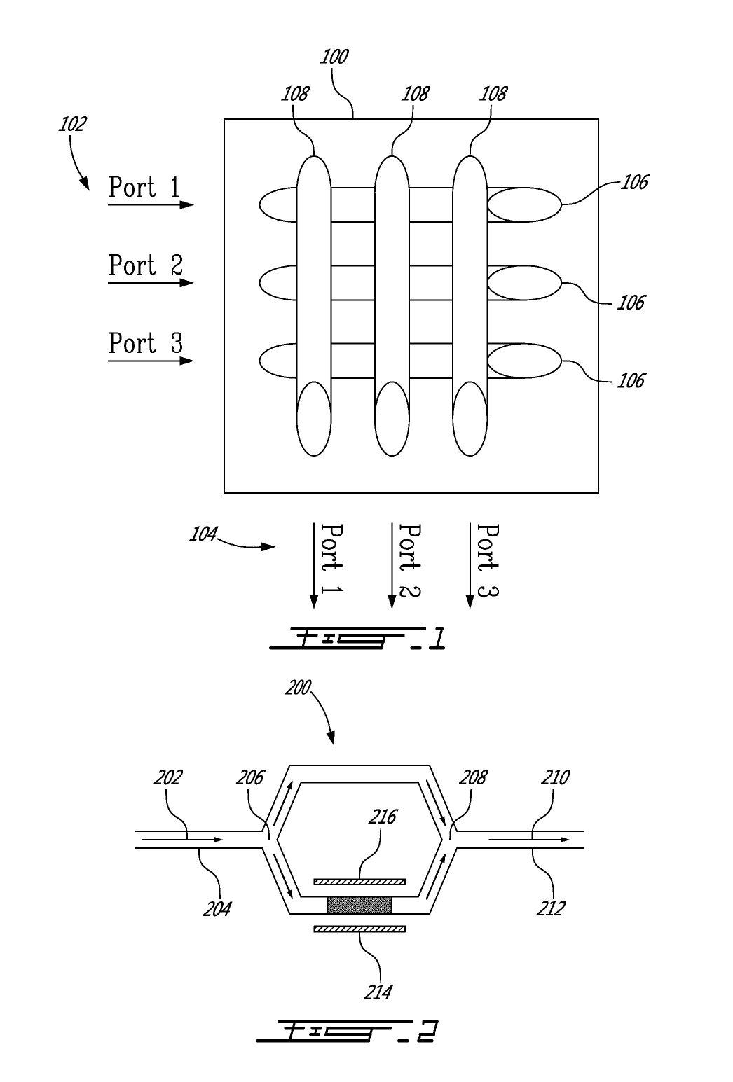

An optical switch or crossbar can be seen as a component with several optical ports connected thereto. Each port can either be a port used to only receive, to only send, or to both receive and send, optical channels. For example, in FIG. 1, the optical switch/crossbar 100 can be seen as having three incoming ports 102 and three outgoing ports 104. As suggested by the phrase “wave division multiplex” (WDM), each port 102, 104 can carry several different optical channels. Each optical channel is characterized by a unique optical wavelength of the light. Similarly, each of the input waveguides 106 and output waveguides 108, which are arranged in a crossbar pattern, can also carry several different optical channels. The waveguides 106, 108 can be implemented using, for example, Planar Light wave Circuit (PLC) technology, i.e., either using glass, fiber, polymer, etc. For clarity, exemplary embodiments can be implemented in an optical switch, an optical crossbar, optical router or other optical crossconnect devices, which latter phrase is used herein generically to include optical switches, optical crossbars and other optical devices.

An interferometer is a device used to interfere two or several waves together, generating a pattern of interference created by their superposition. When two waves with the same frequency combine, the resulting pattern is determined by the phase difference between the two waves-waves that are in phase will undergo constructive interference while waves that are out of phase will undergo destructive interference. Most interferometers use light or some other form of electromagnetic wave.

Typically, a single incoming beam of coherent light will be split into two identical beams by a grating or a partial mirror. Each of these beams will travel a different route, called a path, until they are recombined. By traveling a different path before arriving at the recombination point, a phase difference is created between the two identical beams. It is this introduced phase difference that creates the interference pattern between the initially identical waves. If a single beam has been split along two paths, then the phase difference is diagnostic of anything that changes the phase along the paths. This could be a physical change in the path length itself or a change in the refractive index along the path.

There exist several different types of interferometers, such as the Mach-Zehnder, the Mickelson and the Sagnac interferometer. The choice of the right interferometer for a particular need mainly depends on each interferometer's strengths and weaknesses. In the context of these exemplary embodiments where a large number of interferometers are envisioned to be required in order to provide optical switching capabilities, it seems that the Mach-Zehnder interferometer technology would provide the best solution, however the present invention is not limited to that particular technology. For example, the Mach-Zehnder interferometer seems to offer the best tolerance to misalignment, the best stability, as well as being a commercially proven technology, although other interferometer technologies could be used instead.

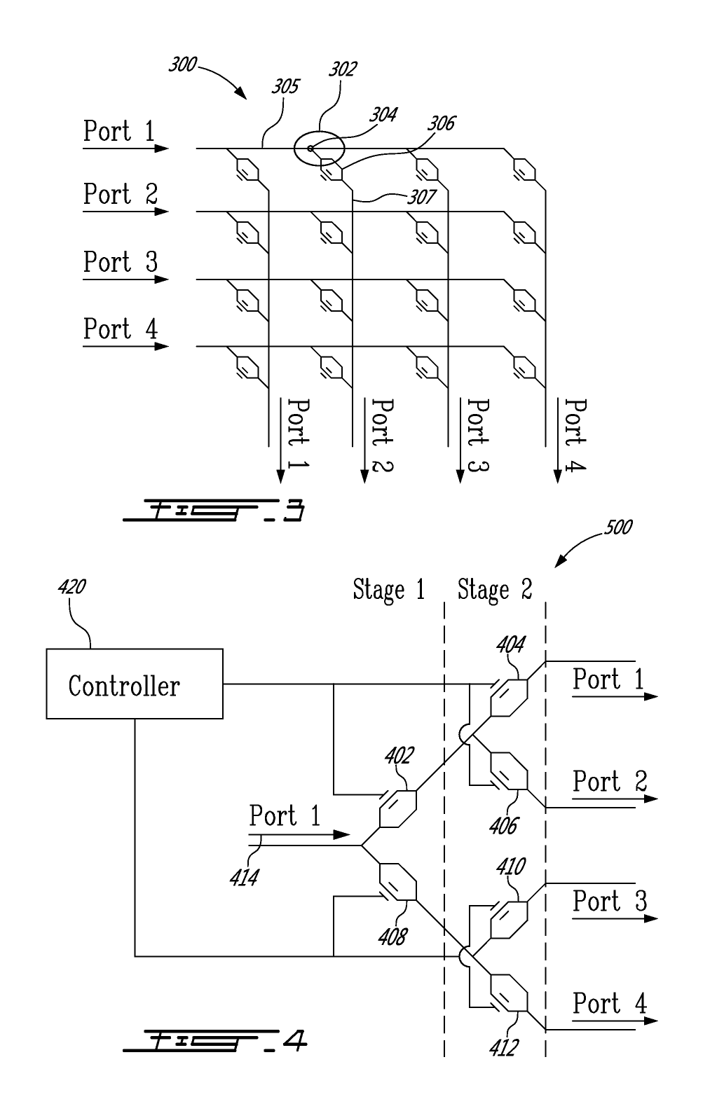

While a Mach-Zehnder interferometer can be used as a phase modulator, exemplary embodiments instead use MZIs as filters, i.e. for their capability to block or not block an optical wavelength. As shown in FIG. 2, an MZI 200 can have an incoming optical signal 202 which is carried by an incoming waveguide 204. At a first junction 206, the incoming optical signal is first split in two and is later recombined at junction 208 into an outgoing optical signal 210 on the outgoing waveguide 212. In the case where no electric field is applied on the lower arm of the Mach-Zehnder device 200, then the optical signal passing on the bottom waveguide will pass through without any phase shift, which means that the optical signal on the outgoing waveguide 212 can be recombined without significant signal degradation. This assumes that, when no electric field is applied on the device via plates 214 and 216, that the two paths of the MZI device 200 allow the original incoming optical signal 202 to avoid any destructive interference in the outgoing waveguide 212.

However, when an electric field is applied to plates 214, 216, then a 180 degree induced phase shift is applied on the optical signal carried by the bottom waveguide, which causes the two optical signals being recombined on the outgoing optical waveguide 212 with a 180 degree phase shift. Such a phase shift is considered to be a destructive interference that blocks completely the incoming optical signal 202 from being output on the outgoing optical waveguide 212. In other words, applying or not an electric field on the bottom waveguide via plates 214, 216 can be used to block, or not block, the incoming optical signal 202. As mentioned earlier, the phase shift can be created by controlling the length of the path, or the refractive index of the waveguide.

Thus, to summarize the MZI 200 of FIG. 2, this exemplary device includes an input, an output, two separate branches connecting the input to the output, a beam splitter which splits an optical signal received by each MZI into two beams which are conveyed over respective ones of said two separate branches, a controllable phase shifter, associated with one of said two separate branches, for selectively inducing a 180 degree phase shift into one of the beams, and a beam combiner for combining optical signals from the two separate branches into one optical signal which is sent to the output.

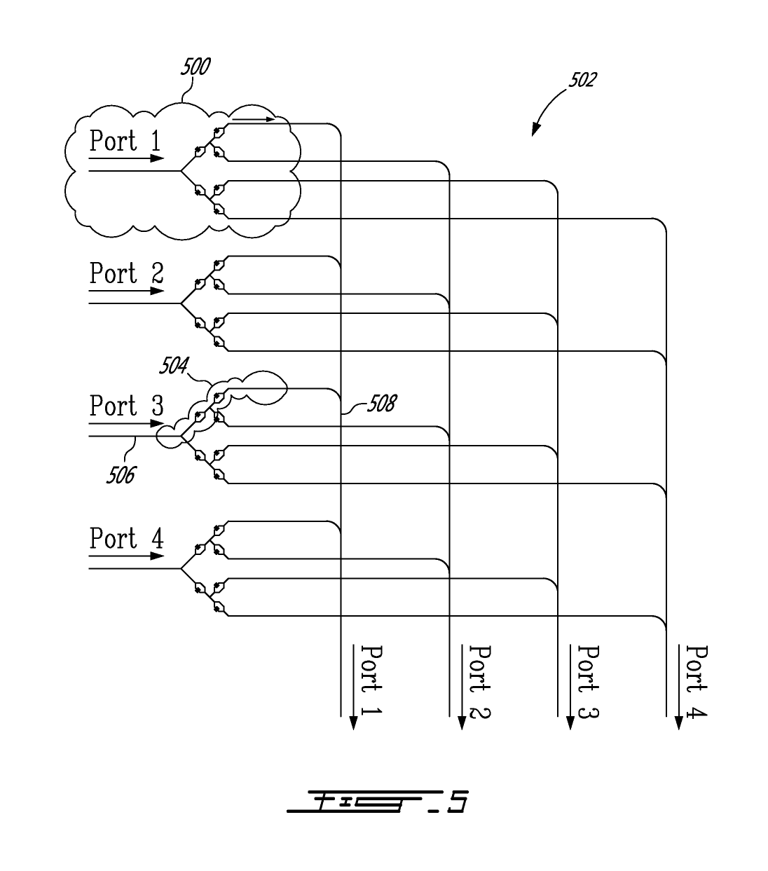

Using, for example, the above-described MZI technology, one way to create an optical crossbar, or switch, according to exemplary embodiments is to combine an orthogonal design of the input and the output optical waveguides with splitters and MZI filters. An example is shown in FIG. 3, wherein a 4×4 optical crossbar/switch 300 having four input waveguides and four output waveguides disposed in a substantially orthogonal relationship relative to each other. Between the input waveguides and the output waveguides is a connecting optical waveguide which includes, at each intersection between an input and an output waveguide, an optical splitter/coupler and a Mach-Zehnder interferometer filter. For example, at junction 302, an optical splitter 304 directs a portion of the optical signal which is being conveyed on input waveguide 305 toward the output waveguide 307. Between the input waveguide 305 and the output waveguide 307, the connecting optical waveguide portion includes MZI filter 306 which is controlled as described above to selectively allow this portion of the input optical signal to proceed on output waveguide 307, or not to proceed, to output port 2 using the technique described above with respect to FIG. 2, e.g., by selectively establishing an electric field across a lower arm of the MZI to change the refractive index of that path. Not shown in FIG. 3, for simplicity of the figure, is a controller and control lines to each of the sixteen MZI filters used in this embodiment which enables the controller to selectively block or unblock each of the MZI filters. An exemplary controller is illustrated below with respect to the exemplary embodiment of FIG. 4.

The input and output waveguides, e.g., 305 and 307 illustrated in FIG. 3 are orthogonal to each other in this exemplary embodiment, in order to minimize the interference at each crossing, assuming that all the waveguides could be made of polymer on a single layer of a PCB. With such a system, it is thus possible to control each MZI in order to let either the optical signal go through or be dropped.

One limitation of this approach is that, at each intersection with an outgoing channel, the optical signal is split in two, which means a loss of approximately 3 dB of the signal strength at each intersection. The more branches (ports), the more signal degradation towards the edge of the switching matrix. For the example of FIG. 3, there are four input and four output ports. Considering that an input port can be seen as a waveguide carrying an incoming optical signal, the 4×4 Mach-Zehnder-based optical crossbar/switch of the exemplary embodiment of FIG. 3 could be used in order to redirect an incoming optical signal towards one or several output ports, or output waveguides. For an incoming optical signal on port 1, the signal would need to be split in three times before reaching the output port 4, thus reducing the original signal strength by 9 dB. Assuming that an MZI can be as small as 20 um×20 um, a large number of MZIs could be integrated on a relatively small device for building an optical crossbar or switch and, thus, this form of signal degradation may be a limiting factor.

According to another exemplary embodiment, in order to minimize the limitation of the 3 dB loss at each splitting intersection according to the exemplary embodiment of FIG. 3, the number of such signal strength degradation can be limited by design. By limiting the number of optical signal splits to N-levels for each incoming optical signal, the maximum signal loss can be better estimated and limited, and optimized as the number of output ports increases. According to an exemplary embodiment, using the concept of a binary tree, N levels of the binary tree can be used to redirect an incoming optical signal to 2^{N} output channels. With such a design, more Mach-Zehnder interferometers are required, but the number of signal splits is controlled by design.

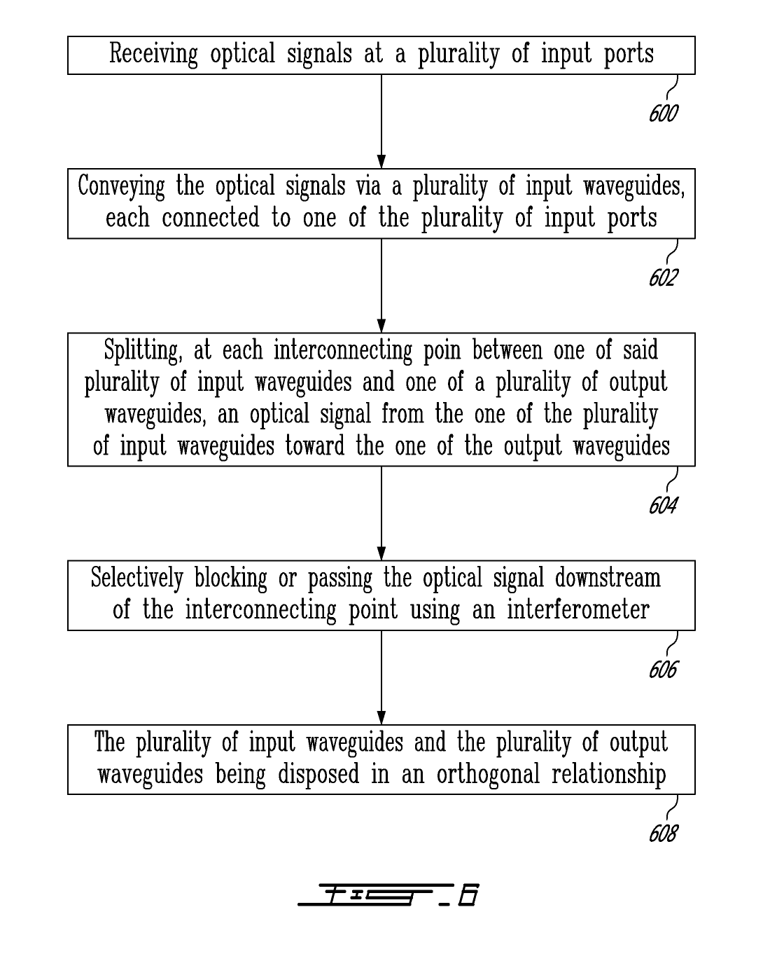

For example, as shown in the exemplary embodiment of FIGS. 4 and 5 (wherein FIG. 4 shows the portion 500 of FIG. 5 in more detail), for a 4×4 optical crossbar/switch 502, six Mach-Zehnder interferometers are used between each input port and the four output ports, as compared with four MZIs between each input port and the four output ports for the for the exemplary embodiment of FIG. 3. However, a maximum of only two signal splits are performed in the exemplary embodiment of FIG. 4 instead of three in the exemplary embodiment of FIG. 3. To see both of these aspects compare the portion 500 of optical switch 502, showing the waveguides, splitters and MZI's 402-412 between input port 1 and output ports 1-4 illustrated in FIG. 4, with the topmost portion of switch 300 in FIG. 3. Thus, with an N-level Mach-Zehnder interferometer binary tree-like design according to this latter exemplary embodiment, it becomes possible to limit the number of optical signal splits to N for 2^{N} ports. In the exemplary embodiment of FIGS. 4 and 5, the connecting optical waveguide portion is thus more complex than that of the embodiment of FIG. 3. More specifically, and as a purely illustrative example, the connecting optical waveguide portion 504 which connects input waveguide 506 (associated with input port 3) with output waveguide 508 (associated with output port 1) includes two optical splitters and two MZIs, as seen in FIG. 5.

Another advantage of the exemplary embodiment of FIGS. 4 and 5 is that only the Mach-Zehnder interferometers directly involved for directing the incoming optical signals need to be prepared to apply an electric field to one of their optical arms since the binary tree is split into stages. For example, let's assume that an input optical signal 414 has to be redirected toward one or both of the output ports 1 and 2. In stage 1, by not applying power to generate an electric field in MZI 402, the optical signal moves to stage 2 and is split before MZI 404 and 406. Then, by applying power to none or to only one of the Mach-Zehnder interferometers 404 and 406 on the stage 2 branch that need to be controlled, the optical signal can be directed to the desired output port(s). In this case, when power is applied, the signal is blocked. Therefore MZIs 410 and 412 in stage 2 of the other branch can be powered down, since the optical signal will be blocked by MZI 408 from traveling further into that branch of the tree. More specifically, the number of stages of interferometers which need to be activated in the binary tree of the exemplary embodiment of FIGS. 4 and 5 can be limited to being only log₂ (number of output ports).

As mentioned above, in order to coordinate the operation of optical crossconnects according to these exemplary embodiments, a controller 420 can be provided for efficiently managing all of the MZIs (only the subset 402-412 shown in FIG. 4), in order to block or not block the optical signals as they traverse the optical waveguide tree, after each splitter (which can be implemented as a 3 dB optical coupler at each junction shown in the Figure). The controller 420 can be responsible for applying (or not applying) an electric field on the MZIs that need to block the optical signals.

In the context where optical signals from several incoming ports are to be switched to one or more outgoing ports, one N-level binary tree-like design can be provided per incoming port as shown in FIG. 5. The incoming ports can be designed parallel to each other, as are the output waveguides from each binary tree structure. Considering that each output port from a binary tree structure corresponds to an outgoing port in such an exemplary embodiment, each output port from a binary tree structure can be multiplexed with the different output ports from each of the other binary tree structures. In fact, in the context of an optical switching device according to this exemplary embodiment, it can be seen that an optical signal could potentially be switched between any of the incoming ports, towards any of the outgoing ports, although this is not a requirement and less multiplexing can be implemented. In order to efficiently perform the multiplexing of each of the output ports from the binary tree structures, it is envisioned that input ports can be positioned orthogonally relative to the output ports as also shown in FIG. 5. With an orthogonal layout between the waveguides for the input and the output ports, it becomes possible to allow each input waveguides to cross several output waveguides, thereby minimizing optical interference.

The foregoing exemplary embodiments present various advantages and benefits in optical switching and crossconnect design. For example, compared with technologies such as MEMS and micro-ring resonators for developing an optical crossbar or switch, another advantage for using MZIs could be that the design can provide a solution for unicast and for multicast traffic. In other words, it is possible to control several MZIs in order to let the optical signal reach only one output port, or several ones. Obviously, the signal strength at the output port will be attenuated depending on the number of stages in the N-level binary tree-like structure, but the signal strength can, however, be the same at every output port when using the exemplary embodiment of FIGS. 4 and 5.

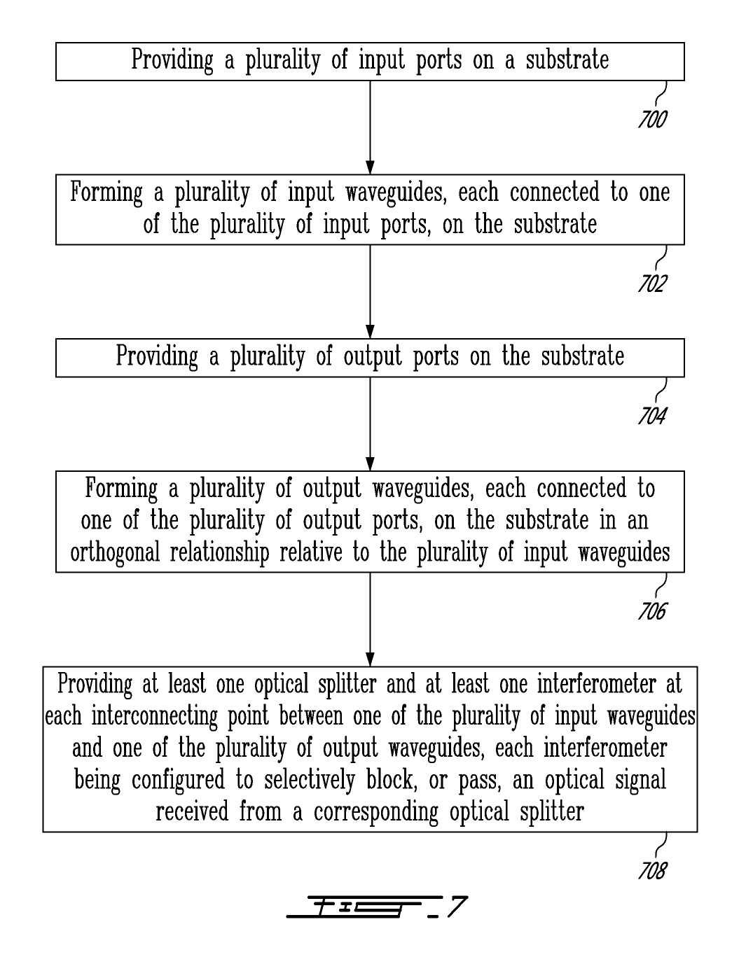

Utilizing the above-described exemplary systems according to exemplary embodiments, a method for conveying optical signals in an optical interconnect is shown in the flowchart of FIG. 6. Therein, at step 600, optical signals are received at a plurality of input ports. The optical signals are then conveyed, at step 602, via a plurality of input waveguides, each corresponding to one of the plurality of input ports. At each interconnecting point between one of the plurality of input waveguides and one of a plurality of output waveguides, an optical signal is split such that a portion of the optical signal is directed toward one of the output waveguides, at step 604. This portion of the optical signal is then selectively blocked, or passed, downstream of the splitter by an interferometer at step 606. The plurality of input waveguides and output waveguides are disposed in an orthogonal relationship, as indicated by step 608.

As mentioned above, exemplary embodiments also provide potential advantages in terms of manufacturing. An exemplary method for manufacturing an optical interconnect device is illustrated in the flowchart of FIG. 7. Therein, a plurality of input ports is provided on a substrate, e.g., a PCB, at step 700. A plurality of input waveguides, each connected to one of the plurality of input ports, is formed on the substrate, at step 702. At step 704, a plurality of output ports are provided on the substrate. A plurality of output waveguides are formed, each connected one of the plurality of output ports, on the substrate in an orthogonal relationship relative to the plurality of input waveguides at step 706. At least one optical splitter and at least one interferometer are provided at each interconnecting point, at step 708, between one of the plurality of input waveguides and one of the plurality of output waveguides, each interferometer being configured to selectively block, or pass, an optical signal received from a corresponding optical splitter

According to another exemplary embodiment, chaining several of the MZI filters described above in a back to back configuration could also be implemented. Assuming, for such an embodiment, that there would be provided as many chained MZIs as there would be wavelengths on an input port, chaining the MZIs in a back to back configuration wherein each MZI can be tuned to selectively block or pass a particular wavelength would provide support for multiple wavelengths per input port. This exemplary embodiment would thus increase the number of MZIs, but allow support for WDM. In the context of the binary-tree like design described above, each MZI would be replaced by a chain of MZIs.

The above-described exemplary embodiments are intended to be illustrative in all respects, rather than restrictive, of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. An optical interconnect system comprising:
a plurality of input ports for receiving optical signals;
a plurality of input waveguides, each connected to one of said plurality of input ports, for guiding said optical signals;
a plurality of output ports;
a plurality of output waveguides, each connected to one of said plurality of output ports;
wherein said plurality of input waveguides and said plurality of output waveguides are disposed in an orthogonal relationship;
at least one connecting optical waveguide portion disposed between each input waveguide and each output waveguide to convey an optical signal from a respective input port toward a respective output port; and
wherein said at least one connecting optical waveguide portion includes at least one optical splitter and at least one interferometer disposed downstream of each optical splitter to selectively block, or let pass, said optical signal toward said respective output port.

2. The optical interconnect system of claim 1, wherein said interferometer is a Mach Zehnder interferometer (MZI).

3. The optical interconnect system of claim 2, wherein said at least one connecting optical waveguide portion includes only one optical splitter and only one MZI.

4. The optical interconnect system of claim 2, wherein all of said at least one connecting optical waveguide portions form a binary tree structure having N stages, wherein N equals log₂ (number of said output ports).

5. The optical interconnect system of claim 4, wherein each of said at least one connecting optical waveguide portions include N splitters and N MZIs.

6. The optical interconnect system of claim 2, wherein each MZI includes:
an input;
an output;
two separate branches connecting the input to the output;
a beam splitter which splits an optical signal received by each MZI into two beams which are conveyed over respective ones of said two separate branches;
a controllable phase shifter, associated with one of said two separate branches, for selectively inducing a 180 degree phase shift into one of said beams; and
a beam combiner for combining optical signals from the two separate branches into one optical signal which is sent to the output.

7. The optical interconnect system of claim 1, further comprising:
a controller connected to each of said interferometers for selectively controlling each interferometer to block or pass an optical signal to route said optical signal from one of said input ports to one or more of said output ports.

8. The optical interconnect system of claim 4, further comprising:
a controller connected to each of said interferometers for selectively controlling each interferometer to block or pass an optical signal to route said optical signal from one of said input ports to one or more of said output ports, wherein to route said optical signal to only one of said output ports said controller only needs to control N stages of said MZIs.

9. A method for conveying optical wavelengths in an optical interconnect, comprising:
receiving optical signals at a plurality of input ports;
conveying said optical signals via a plurality of input waveguides, each connected to one of said plurality of input ports;
splitting, at each interconnecting point between one of said plurality of input waveguides and one of a plurality of output waveguides, an optical signal from said one of said plurality of input waveguides toward said one of said output waveguides; and
selectively blocking or passing said optical signal downstream of said interconnecting point using an interferometer;
wherein said plurality of input waveguides and said plurality of output waveguides are disposed in an orthogonal relationship.

10. The method of claim 9, wherein said interferometer is a Mach Zehnder interferometer (MZI).

11. The method of claim 10, wherein said steps of splitting and selectively blocking are performed by a single optical splitter and a single MZI between each of said plurality of input waveguides and said plurality of output waveguides.

12. The method of claim 10, wherein said steps of splitting and selectively blocking are performed by a binary tree structure having N stages each having an optical splitter and at least one MZI, wherein N equals log₂ (number of said output ports).

13. The method of claim 10, wherein each MZI includes:
an input;
an output;
two separate branches connecting the input to the output;
a beam splitter which splits an optical signal received by each MZI into two beams which are conveyed over respective ones of said two separate branches;
a controllable phase shifter, associated with one of said two separate branches, for selectively inducing a 180 degree phase shift into one of said beams; and
a beam combiner for combining optical signals from the two separate branches into one optical signal which is sent to the output.

14. The method of claim 9, further comprising:
selectively controlling each interferometer to block or pass an optical signal to route said optical signal from one of said input ports to one or more of said output ports.

15. The method of claim 12, further comprising:
selectively controlling each interferometer to block or pass an optical signal to route said optical signal from one of said input ports to one or more of said output ports, wherein to route said optical signal to only one of said output ports only N stages of said MZIs need to be controlled.

16. A method for manufacturing an optical interconnect system comprising:
manufacturing an optical interconnect device by:
providing a plurality of input ports on a substrate;
forming a plurality of input waveguides, each connected to one of said plurality of input ports, on said substrate;
providing a plurality of output ports on said substrate;
forming a plurality of output waveguides, each connected to one of said plurality of output ports, on said substrate in an orthogonal relationship relative to said plurality of input waveguides; and
providing at least one optical splitter and at least one interferometer at each interconnecting point between one of said plurality of input waveguides and one of said plurality of output waveguides, each interferometer being configured to selectively block, or pass, an optical signal received from a corresponding optical splitter.

17. The method of claim 16, wherein said interferometer is a Mach Zehnder interferometer (MZI).

18. The method of claim 17, wherein said step of providing at least one optical splitter and at least one interferometer at each interconnecting point further comprises:
providing a single optical splitter and a single MZI between each of said plurality of input waveguides and said plurality of output waveguides.

19. The method of claim 17, wherein said step of providing at least one optical splitter and at least one interferometer at each interconnecting point further comprises:
providing a binary tree structure having N stages, each stage having an optical splitter and at least one interferometer, wherein N equals log₂ (number of said output ports).

20. The method of claim 17, wherein each MZI includes:
an input;
an output;
two separate branches connecting the input to the output;
a beam splitter which splits an optical signal received by each MZI into two beams which are conveyed over respective ones of said two separate branches;
a controllable phase shifter, associated with one of said two separate branches, for selectively inducing a 180 degree phase shift into one of said beams; and
a beam combiner for combining optical signals from the two separate branches into one optical signal which is sent to the output.
